(19) United States
(12) Patent Application Publication
(10) Pub. No.: US 2018/0039884 A1
(43) Pub. Date: Feb. 8, 2018

(54) SYSTEMS, METHODS AND DEVICES FOR NEURAL NETWORK COMMUNICATIONS

(71) Applicants: Barnaby DALTON, Mississauga (CA); Vanessa COURVILLE, Etobicoke (CA); Manuel SALDANA, Toronto (CA)

(72) Inventors: Barnaby DALTON, Mississauga (CA); Vanessa COURVILLE, Etobicoke (CA); Manuel SALDANA, Toronto (CA)

(21) Appl. No.: 15/227,471

(22) Filed: Aug. 3, 2016

(51) Int. Cl. G06N 3/08; G06N 3/04

(52) U.S. Cl. CPC G06N 3/08; G06N 3/04

(57) ABSTRACT

A system for training a neural network includes a first set of neural network units and a second set of neural networking units. Each neural network unit in the first set is configured to compute parameter update data for one of a plurality of instances of a first portion of the neural network. Each neural network unit in the first set includes a communication interface for communicating its parameter update data for combination with parameter update data from another neural network unit in the first set. Each neural network unit in the second set is configured to compute parameter update data for one of a plurality of instances of a second portion of the neural network. Each neural network unit in the second set includes a communication interface for communicating its parameter update data for combination with parameter update data from another neural network unit in the second set.

### FIELD

Embodiments described herein relate generally to systems, devices, circuits and methods for neural networks, and in particular, some embodiments relate to systems, devices, circuits and methods for communications for neural networks.

### BACKGROUND

Parallelism can be applied to data processes such as neural network training to divide the workload between multiple computational units. Increasing the degree of parallelism can shorter the computational time by dividing the data process into smaller, concurrently executed portions. However, dividing a data process can require the communication and combination of output data from each computational unit.

In some applications, the time required to communicate and combine results in a parallel data process can be significant and may, in some instances, exceed the computational time. It can be a challenge to scale parallelism while controlling corresponding communication costs.

### DESCRIPTION OF THE FIGURES

FIG. 1 is a schematic diagram showing aspects of an example deep neural network architecture.

FIG. 2 is a schematic diagram showing an example training data set.

FIGS. 3A and 3B are schematic and data flow diagrams showing aspects of different example neural network architectures and data processes.

FIG. 4 is a schematic diagram showing aspects of an example neural network architecture.

FIG. 5 is a schematic diagram showing aspects of an example neural network architecture and data process.

FIG. 6 is a schematic diagram showing aspects of an example neural network unit.

FIG. 7 is a schematic diagram showing aspects of an example neural network.

FIG. 8 is a schematic diagram showing aspects of an example neural network instance.

FIG. 9 is a schematic diagram showing aspects of an example neural network architecture and data process.

FIG. 10 is a schematic diagram showing aspects of an example neural network architecture and data process.

FIG. 11 is a schematic diagram showing aspects of an example neural network architecture and data process.

FIG. 12 is a flowchart showing aspects of an example method for a training a neural network.

These drawings depict example embodiments for illustrative purposes, and variations, alternative configurations, alternative components and modifications may be made to these example embodiments.

### SUMMARY

In an aspect, there is provided a system for training a neural network having a plurality of interconnected layers. The system includes a first set of neural network units and a second set of neural networking units. Each neural network unit in the first set is configured to compute parameter update data for one of a plurality of instances of a first portion of the neural network. Each neural network unit in the first set includes a communication interface for communicating its parameter update data for combination with parameter update data from another neural network unit in the first set. Each neural network unit in the second set is configured to compute parameter update data for one of a plurality of instances of a second portion of the neural network. Each neural network unit in the second set includes a communication interface for communicating its parameter update data for combination with parameter update data from another neural network unit in the second set.

In another aspect, there is provided a method for training a neural network with an architecture having a plurality of instances of the neural network. The method includes: for each neural network unit in a first set of neural network units configured to compute parameter update data for one of a plurality of instances of a first portion of the neural network, communicating the parameter update data generated by the neural network unit for combination with parameter update data from another neural network unit in the first set; and for each neural network unit in a second set of neural network units configured to compute parameter update data for one of a plurality of instances of a second portion of the neural network, communicating the parameter update data generated by the neural network unit for combination with parameter update data from another neural network unit in the second set.

In another aspect, there is provided a non-transitory, computer-readable medium or media having stored thereon computer-readable instructions. When executed by at least one processor, the instructions configure the at least one processor to: for each neural network unit in a first set of neural network units configured to compute parameter update data for one of a plurality of instances of a first portion of a neural network, communicate the parameter update data generated by the neural network unit for combination with parameter update data from another neural network unit in the first set; and for each neural network unit in a second set of neural network units configured to compute parameter update data for one of a plurality of instances of a second portion of the neural network, communicate the parameter update data generated by the neural network unit for combination with parameter update data from another neural network unit in the second set.

### DETAILED DESCRIPTION

In the field of machine learning, artificial neural networks are computing structures which use sets of labelled (i.e. pre-classified) data to ‘learn’ their defining features. Once trained, the neural network architecture may then be able to classify new input data which has not been labeled.

The training process is an iterative process which can involve a feed-forward phase and a back-propagation phase. In the feed-forward phase, input data representing sets of pre-classified data is fed through the neural network layers and the resulting output is compared with the desired output. In the back-propagation phase, errors between the outputs are propagated back through the neural network layers, and corresponding adjustments are made to neural network parameters such as interconnection weights.

In some applications, a training data set can include hundreds of thousands to millions of input data sets. Depending on the complexity of the neural network architecture, training a neural network with large data sets can take days or weeks.

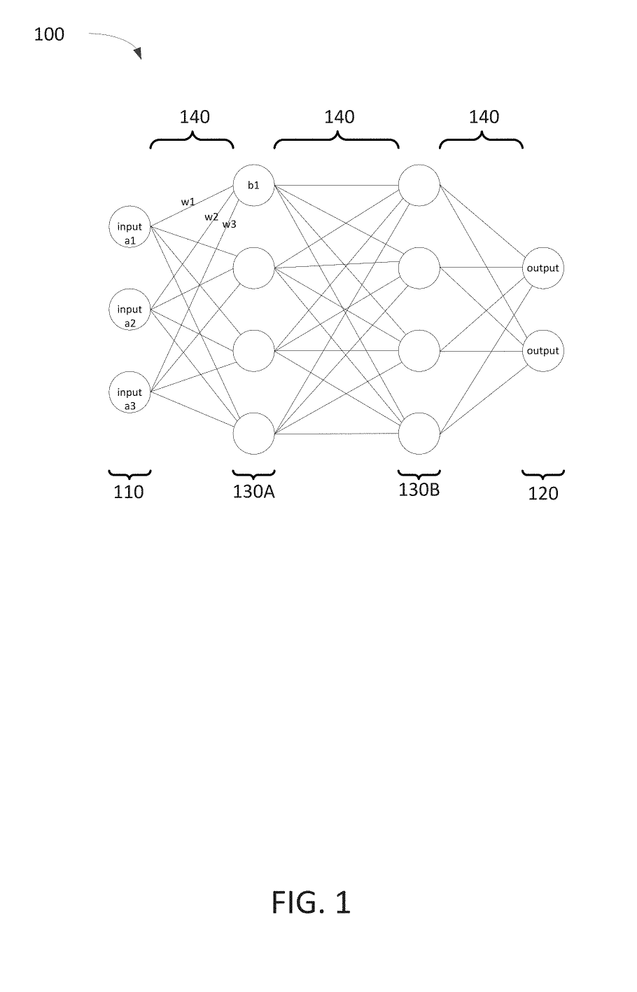

FIG. 1 shows an example deep neural network architecture 100. A deep neural network (DNN) can be modelled as two or more artificial neural network layers 130A, 130B between input 110 and output 120 layers. Each layer can include a number of nodes with interconnections 140 to nodes of other layers and their corresponding weights. The outputs of the deep neural network can be computed by a series of data manipulations as the input data values propagate through the various nodes and weighted interconnects. In some examples, deep neural networks include a cascade of artificial neural network layers for computing various machine learning algorithms on a data set.

Each layer can represent one or more computational functions applied to inputs from one or more previous layers. In some layers, to calculate an intermediate value at a node in the DNN, the neural network sums the values of the previous layer multiplied by the weights of the corresponding interconnections. For example, in FIG. 1, the value at node b1 is a1*w1+a2*w2+a3*w3.

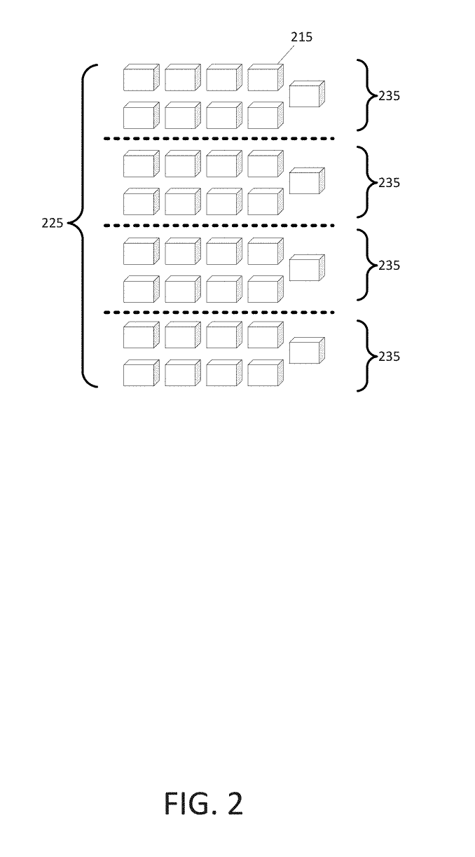

In a simple example, FIG. 2 shows a complete training data set 225 having thirty-six input data sets 215. Each input data set can include a multiple of input data points and one or more expected outputs. For example, for an image recognition neural network, an input data set can include pixel data for an image and one or more image classification outputs (e.g. for an animal recognition neural network, the outputs can include outputs indicating if the image includes a dog or a cat). The input data sets can include any type of data depending on the application of the neural network.

During training, a large training input data set 225 can be split into smaller batches or smaller data sets, sometimes referred to as mini-batches 235. In some instances, the size and number of mini-batches can affect time and resource costs associated with training, as well as the performance of the trained neural network (i.e. how accurately the neural network classifies data).

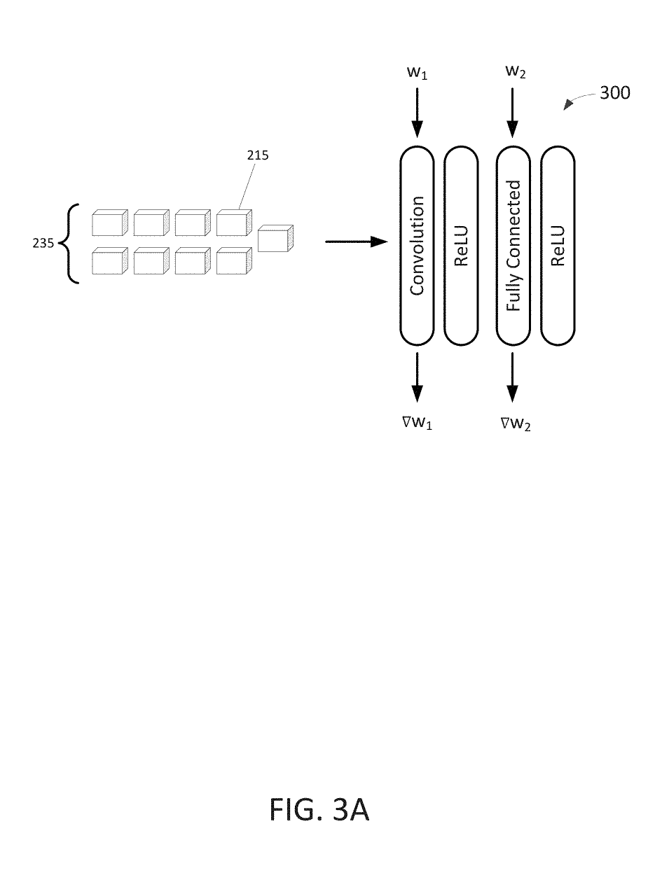

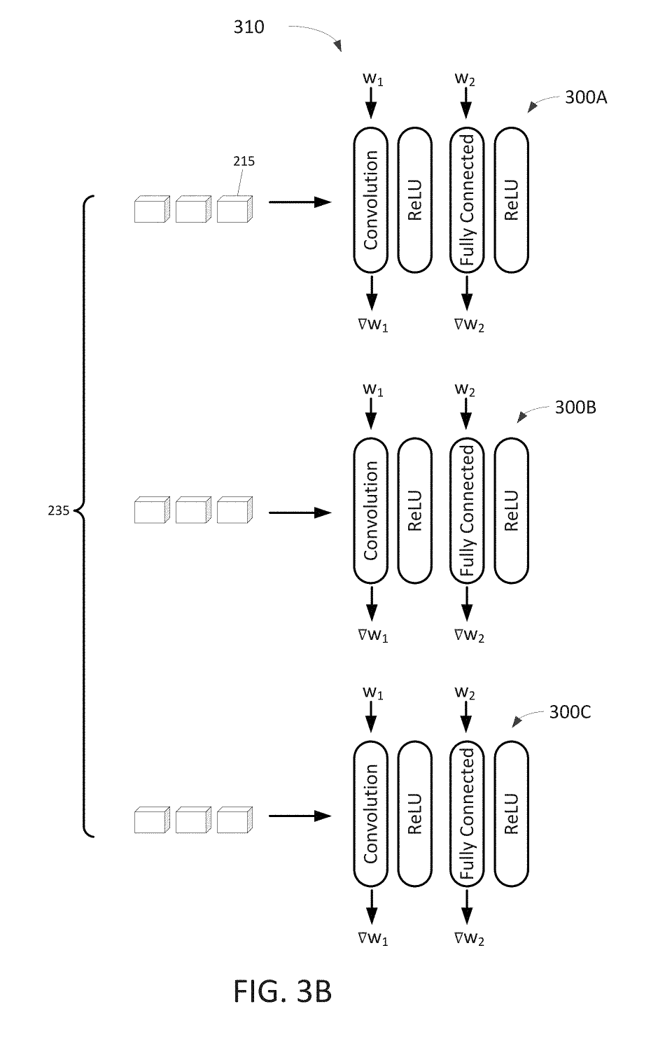

As illustrated by FIG. 3A, each mini-batch is fed through a neural network architecture 300. During the feed forward stage, one or more of the layers of the neural network process the mini-batch data using one or more parameters such as weights w₁ and w₂. During the back-propagation stage, parameter adjustments are calculated based on the back propagation of errors between the calculated and expected outputs. In some embodiments, these parameter updates are applied before the next mini-batch is processed by the neural network.

To introduce parallelism, a neural network architecture can include multiple instances of a neural network with each instance computing data points in parallel. For example, FIG. 3B shows an example neural network architecture 310 including three instances of the neural network 300A, 300B, 300C. Rather than all nine of the data sets 215 of the mini-batch 235 being processed by a single neural network (as in FIG. 3A), the mini-batch 235 is split into three with each neural network instance 300A, 300B, 300C processing a different subset of the mini-batch.

While processing a mini-batch, each instance applies the same parameters and accumulates different parameter adjustments based on the respective portion of the mini-batch processed by the instance during the back-propagation phase. After parameter adjustments are calculated, the adjustments from each neural network instance 300A, 300B, 300C must be combined and applied to each instance. This requires the communication of the parameter adjustments between neural network instances.

In some embodiments, parameter adjustments can be combined at a central node. In some scenarios, this can create a communication bottleneck as parameter adjustments are communicated to and from the central node for combination and redistribution after each mini-batch.

In some embodiments, aspects of the present disclosure may reduce communication bottlenecks and/or may reduce the overhead time caused by communications during the parameter adjustment phase. In some instances, this may reduce the amount of time required to train a neural network.

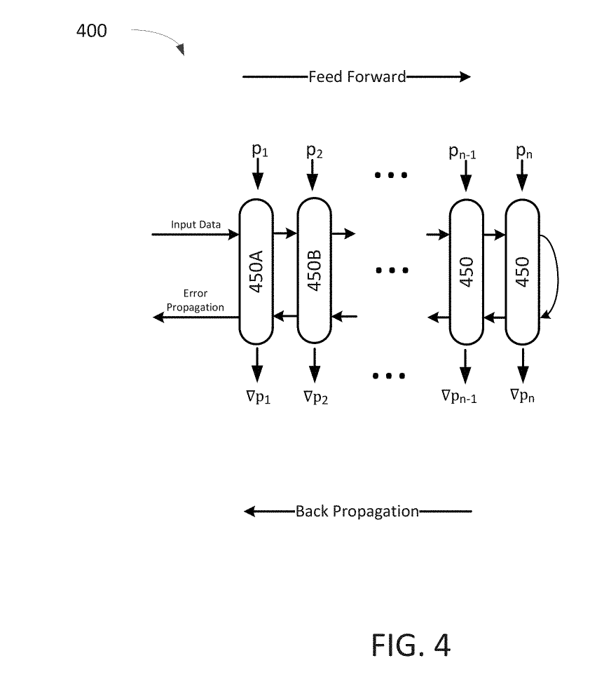

FIG. 4 shows an example neural network architecture 400 having n layers 450. Each layer 450 in the architecture 400 can rely on one or more parameters p₁ . . . pₙ to process input data. In some embodiments, a single layer may utilize a single parameter, multiple parameters, or no parameters. For example, a fully-connected layer (see for example FIG. 1) may have anywhere from a few parameters to millions of parameters in the form of interconnect weights. Another example is a layer which performs a constant computation and does not rely on any parameters.

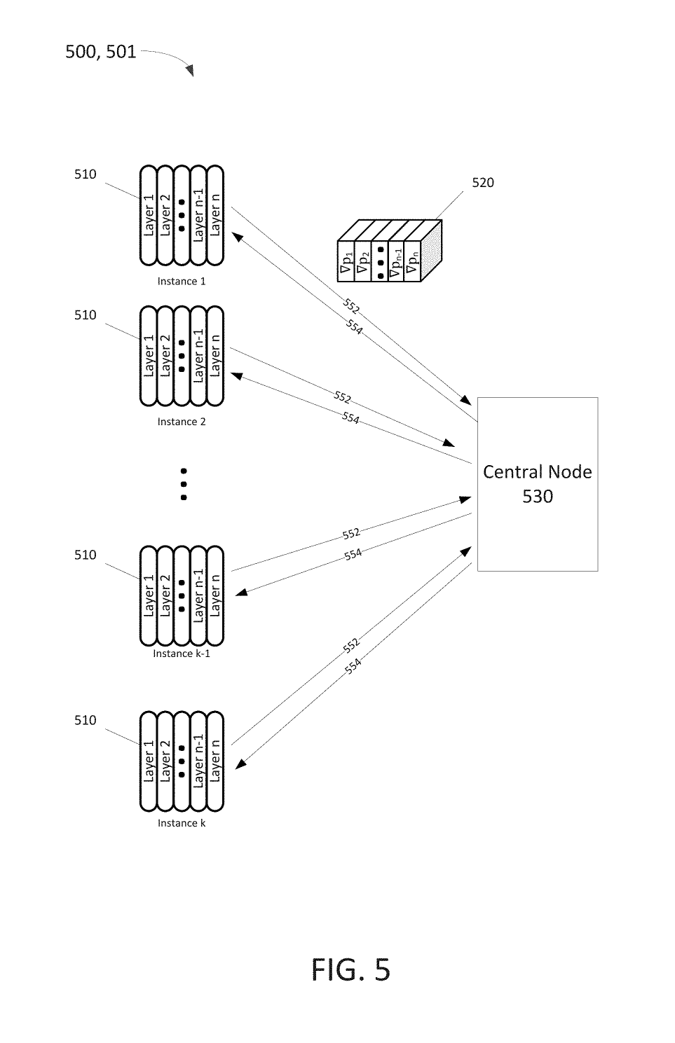

FIG. 5 shows an example data flow diagram illustrating a parameter update process 500 for a neural network architecture 501. The neural network architecture 501 includes k parallel instances 510 of the n-layer neural network. After each instance 510 processes its portion of a mini-batch, each instance generates its own set of parameter update data 520 including parameter updates across all layers of the neural network. These sets of parameters update data 520 are transmitted 552 to a central node 530 to be combined. Once combined, the central node 530 transmits the combined parameter update data back to each of the neural network instances.

In some embodiments, the transmission of parameter update data to and from the central node 530 can suffer from a bottleneck at the communication interface with the central node 530. For example, if each layer has a corresponding parameter update data set having a size of Wᵢ=|∇pᵢ|, then the total size of the set of parameter updates 520 for all the layers is

W=W₁+W₂+ . . . +Wₙ.

In the architecture 501 in FIG. 5, the total amount of data being transmitted to the central node 530 is

k*W.

The total in-out traffic at the central node 530 is twice this (2*k*W) as the combined updated parameter data is sent back to the neural network instances 510.

In some applications, the size of the total update data set 520 can be large. For example, AlexNet, a neural network for image classification, has eight weighted layers and 60 million parameters. In some embodiments, the total update data set 520 for a single neural network instance can be W=237 MB.

With any number of neural network instances k, the time required to communicate parameter update data sets to and from the central node 530 can be significant. For example, in some architectures with 16 to 32 instances of a neural network, it has been observed that communication time can account for as much as 50% of the training time of a neural network.

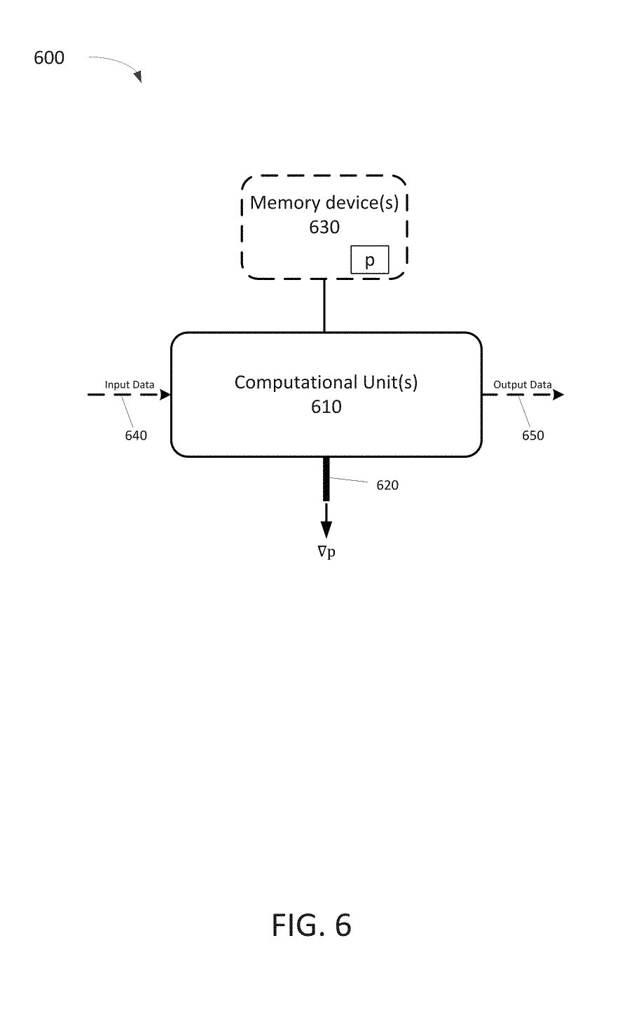

FIG. 6 is a schematic diagram showing aspects of a neural network unit 600 which can be part of a larger neural network architecture.

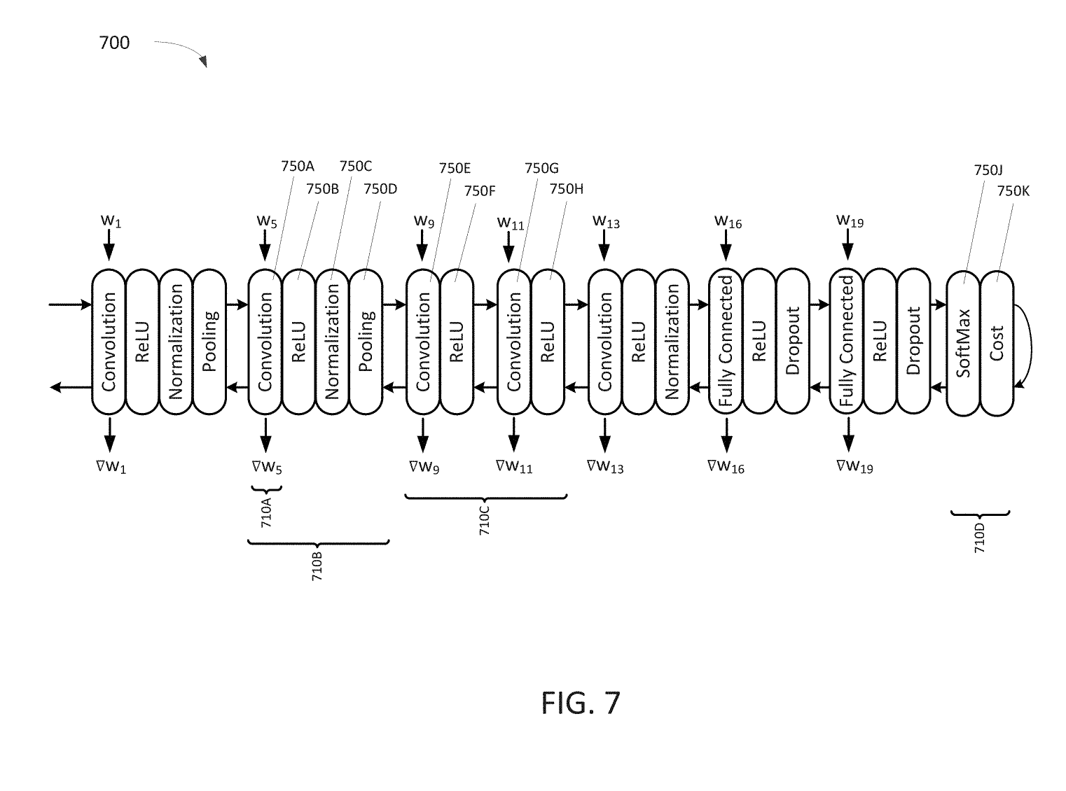

In some embodiments, a neural network unit 600 is configured to compute or otherwise generate parameter update data for a portion of a neural network instance. In some embodiments, a neural network unit 600 includes components configured to implement a portion of a neural network architecture corresponding to aspects of a single layer of the neural network. For example, with reference to the neural network instance 700 in FIG. 7, an example neural network portion is identified by reference 710A which includes a single layer 750A that generates parameter update data ∇w₅.

In some embodiments, a neural network unit includes components configured to implement multiple layers which comprise a subset of a whole neural network instance. For example, an example neural network portion is identified by reference 710B. Rather than a single layer, this neural network portion includes layers 750A, 750B, 750C and 750D. In some embodiments, the neural network portion can include aspects of consecutive layers in a neural network instance 700.

In another example, neural network portion 710C includes aspects of layers 750E, 750F, 750G, and 750H. In this example, the neural network portion 710C generates parameter update data ∇w₉, ∇w₁₁ for multiple layers 750E, 750G.

In another example, neural network portion 710D includes aspects of layers 750J and 750K. In this example, the neural network portion 710D does not generate any parameter update data.

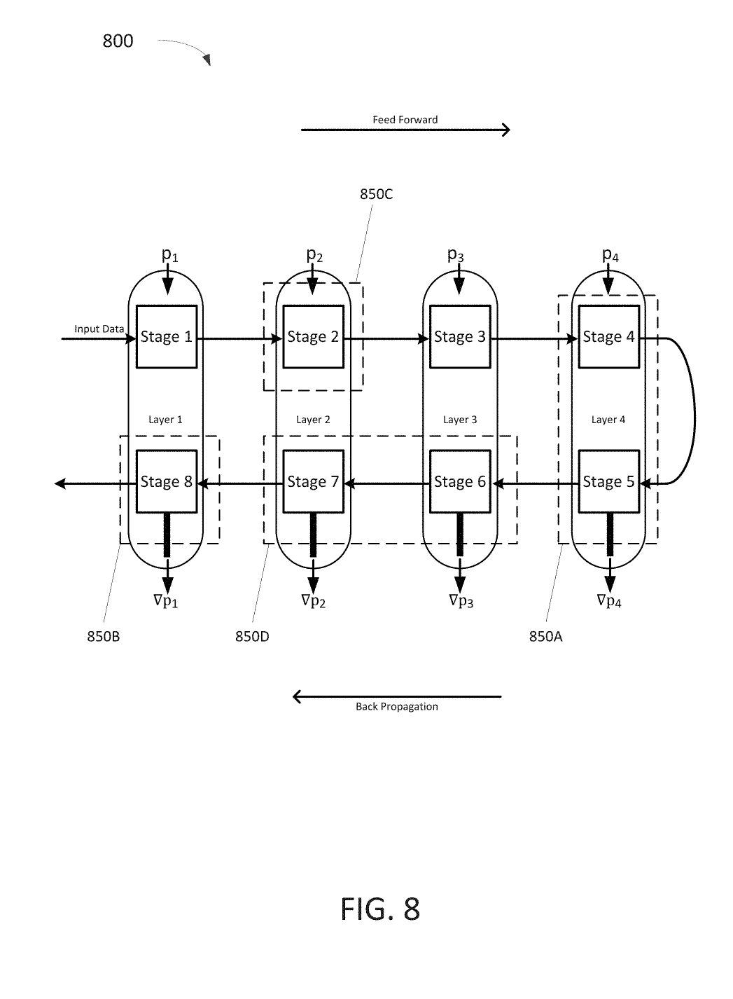

With reference to another neural network instance 800 in FIG. 8, in some embodiments, a neural network unit can be configured to implement a portion of a neural network layer. For example, a neural network unit can include components configured to implement both feed forward and back propagation stages of a layer as illustrated by neural network unit 850A.

In another example, a neural network unit can include components configured to implement aspects of the back propagation stage of a layer as illustrated by neural network unit 850B. In another example, a neural network unit can include components configured to implement aspects of a feed forward stage of a layer as illustrated by neural network unit 850C.

In another example, a neural network unit can include components configured to implement portions of multiple layers such as the back propagation stages of multiple layers as illustrated by neural network unit 850D.

In another example, two different neural network units can generate the parameters for a single layer. For example, Stage 8 in FIG. 8 can be split into two neural network units with each unit generating and communicating a different portion of the Layer 1 parameter updates ∇p₁.

In another example, a neural network unit can include non-contiguous portions in the data-flow of the neural network.

In general embodiments, a neural network instance can comprise two or more neural network units. A neural network unit can be any proper subset of a neural network instance. In some embodiments, notwithstanding the data flow dependencies between neural network units, the logical division of a neural network instance into neural network units allows the communication aspects of each unit to perform their communication tasks or to otherwise have network access independently of other units.

In some embodiments, in the design of a neural network architecture, the division of a neural network instance into neural network units can be based on balancing computation times across units and/or coordinating communication period to avoid or reduce potential communication congestion.

With reference again to FIG. 6, in some embodiments, a neural network unit 600 includes one or more computational units 610 configured to compute or otherwise generate parameter update data for one or more layers in the neural network. For example, a computational unit 610 can be configured to perform multiplications, accumulations, additions, subtractions, divisions, comparisons, matrix operations, down sampling, up sampling, convolutions, drop outs, and/or any other operation that may be used in a neural network process.

In some embodiments, the computational units 610 can include one or more processors configured to perform one or more neural network layer operations on incoming error propagation data 640 to generate parameter update data. For example, in some embodiments, a computational unit 610 may be implemented on and/or include a graphics processing unit (GPU), a central processing unit (CPU), one or more cores of a multi-core device, and the like.

In some embodiments, different neural network layers (in the same neural network instance and/or in different instances) are implemented using or otherwise provided by different neural network units 600. Different computational units 610 for different neural network units 600 can, in some embodiments, be distributed across processors in a device. In other embodiments, the neural network units and corresponding computational units 610 can be distributed across different devices, racks, or systems. In some embodiments, the neural network units 600 can be implemented on different resources in a distributed resource environment.

In some embodiments, the neural network unit 600 is part of an integrated circuit such as an application-specific integrated circuit (ASIC) or field-programmable gate array (FPGA). In some such embodiments, a computational unit 610 includes a logic/computational circuit, a number of configurable logic blocks, a processor, or any other computational and/or logic element(s) configured to perform the particular data processing for the corresponding layer.

Depending on the architecture of the neural network, the input data sets 215 of a mini-batch can be streamed through the neural network layers and/or they can be processed as a batch. In some embodiments, the computational units 610 are configured to generate parameter update data by accumulating or otherwise combining parameter updates computed for each input data set 215 in a batch/mini-batch.

The computational unit 610, in some embodiments, includes, is connected to, or is otherwise configured to access one or more memory devices 630. In some embodiments, the memory devices 630 may be internal/embedded memory blocks, memory logic array blocks, integrated memory devices, on-chip memory, external memory devices, random access memories, block RAMs, registers, flash memories, electrically erasable programmable read-only memory, hard drives, or any other suitable data storage device(s)/element(s) or combination thereof. The memory device(s) 630 can, in some embodiments, be configured to store parameter data, error propagation data, and/or any other data and/or instructions that may be used in the performance of one or more aspects of a neural network layer.

The computational unit 610, in some embodiments, is configured to access the memory device(s) 630 to access parameter values for the computation of a parameter update value, an error value, and/or a value for use in another layer.

In some embodiments, the memory device(s) 630 are part of the neural network unit 600. In other embodiments, the memory device(s) 630 are separate from the neural network unit 600 and may be accessed via one or more communication interfaces.

In some embodiments, the neural network unit 600 is configured to receive or access input data 640 from an input data set or from a previous neural network unit in the neural network instance. In some embodiments, the input data may be received via a communication interface 640 and/or a memory device 630. The input data may include values for processing during the feed forward phase and/or error propagation values for processing during the back propagation phase.

Based on the input data and any parameters p, the computational unit can, in some instances, be configured to compute or otherwise generate output data for a subsequent layer in the neural network and/or parameter update data. In some embodiments, the neural network unit 600 is configured to communicate the output data via a communication interface 650 and/or a memory device 630.

The neural network unit 600 includes at least one communication interface 620 for communicating parameter update data ∇p for combination with parameter update data from one or more other neural network units 600. In some embodiments, the at least one communication interface 620 provides an interface to a central node or another neural network unit 600. In some embodiments, the parameter update data from one neural network unit 600 can be communicated to another neural network unit 600 via the at least one communication interface and central node as part of a combined parameter update.

In some embodiments, the communication interface 620 for communicating the parameter update data can be the same interface as the interface for receiving the input data 640 and/or the interface for communicating the output data 650 and/or an interface to the memory device(s) 630. In other embodiments, the communication interface 620 for communicating the parameter update data can be a separate interface from other interface(s) for communicating input data, output data or memory data.

Is some embodiments, the at least one communication interface 620 provides an interface for communicating the parameter update data via one or more busses, interconnects, wires, circuits and/or any other connection and/or control circuit, or combination thereof. For example, the communication interface 620 can, in some instances, provide an interface for communicating data between components of a single device or circuit.

In some embodiments, the at least one communication interface 620 provides an interface for communicating the parameter update data via one or more communication links, communication networks, routing/switching devices, backplanes, and/or the like, or any combination thereof. For example, the communication interface 620 can, in some instances, provide an interface for communicating data between neural network components across separate devices, networks, systems, etc.

Since each neural network unit has its own interface over, in some situations, each neural network unit can generally communicate its parameter update data without necessarily being constraining or having to wait for the data for another neural network unit to be computed. In some embodiments, this may allow for parameter update communications for the system as a whole to be spread across different connections and/or networks, and in some situations, to be spread out temporally. In some applications, this may reduce the effective communication time for a neural network training process, and may ultimately speed up the training process.

In some embodiments, the neural network unit 600 is configured to receive combined parameter update data and to update the parameter data in the memory device(s) 630 based on the received combined parameter update data. In some embodiments, the combined parameter update data can be received via one of the communication interfaces 620. In some embodiments, the computational unit(s) 610 and/or another processor or component of the neural network unit 600 is configured to update the parameter data in the memory device(s) 630. In some instances, the updating the parameter data can include accessing the current parameter data, computing the new parameter data based on the current parameter data and the combined parameter update data, and having the resulting parameter data stored in the memory device(s) 630.

As described herein, in some embodiments, systems, circuits, devices and/or processes may implement a neural network architecture. The neural network architectures described herein or otherwise can be provided with a system including multiple neural network units 600. In some embodiments, the systems, circuits, devices and/or processes can utilize communication links/networks/devices, memory devices, processors/computation units, input devices, output devices, and the like. In some embodiments, one or more processors or other aspect(s) of a system/device are configured to control the distribution/communication/routing of input data sets, parameter update data, combined parameter update data, and the like. In some embodiments, the system is configured to and/or contains any components for coordinating the training of the neural network.

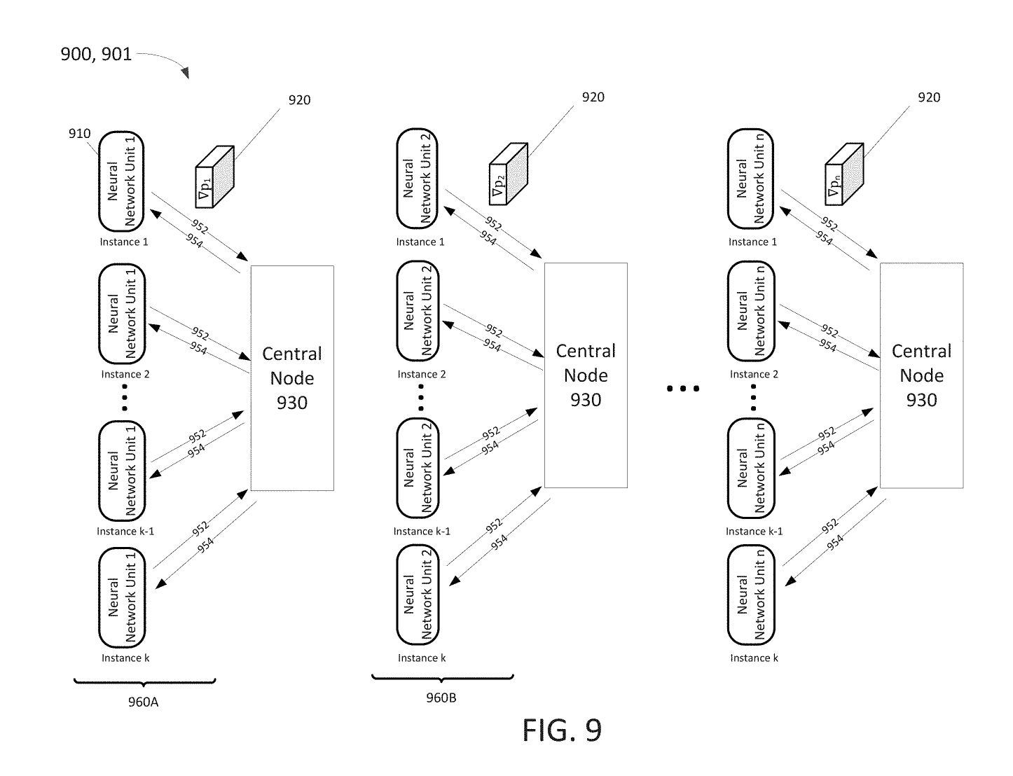

FIG. 9 shows an example data flow diagram illustrating an example parameter update process 900 for a neural network architecture 901. The neural network architecture 901 includes k parallel neural network instances. Each neural network instance includes an instance of each neural network unit 1 through n.

All of the instances of the same neural network unit can be referred to as a set. For example, a first set of neural network units 960A includes Neural Network Unit 1 for all k instances of the neural network. Similarly, a second set of neural network 960B includes each instance of Neural Network Unit 2. In some embodiments, all neural network units in the same set are configured to provide the same portion of a neural network.

It should be understood that references to ‘first’ and ‘second’ and other similar terms should be understood as their nominal terms, and without additional context should not be interpreted as relating to any particular location or order, nor should it be interpreted as having any numerical significance. For example, neural network unit set 960B can, in different contexts, be referred to as a first set or a second set.

With reference to the initial set of neural network units 960A, during a training process, data sets are processed by the k instances of the neural network units 910 in the initial set 960A (each instance labelled Neural Network Unit 1 in FIG. 9), each generating parameter update data 920 for the portion of the neural network training process provided by the neural network unit.

In some embodiments, the parameter update data 920 includes data for updating one or more parameters for the neural network unit. For example, in some embodiments, the parameter update data 920 can include incremental values by which one or more parameters should be adjusted.

These sets of parameters update data 920 are transmitted 952 to a central node 930 to be combined. Once combined, the central node 930 transmits the combined parameter update data back to each of the neural network instances. In some embodiments, the central node 930 includes one or more computational units configured to combine the parameter update data received from each neural network unit. In some embodiments, combining the parameter update data can include, adding, subtracting, dividing, averaging, or otherwise combining the parameter update data into a combined update data.

After generating the combined parameter update data, the central node 930 is configured to communicate 954 the combined parameter update data to each of the neural network units 910 in the set 960A.

In some embodiments, neural network units which utilize parameters but do not generate parameter updates (e.g. feed-forward components), these sets of units will not produce or communicate updates but can be configured to receive and process parameter updates.

In some instances, by dividing the neural network instances into portions, the size of the parameter update data set 920 of each neural network unit 910 is a fraction of the total parameter update data set 520 illustrated in FIG. 5. Specifically, the total size of the set of parameter updates 920 for a neural network unit is Wᵢ=|∇pᵢ|, namely, the sum of the magnitudes of each parameter update in the data set 920.

Therefore, in the example architecture 901 of FIG. 9, the total amount of data being transmitted to the central node 530 for a set of neural network units (e.g. 960A, 960B) is k*Wᵢ which can be significantly smaller than k*(W₁+W₂+ . . . +Wₙ) for the architecture in FIG. 5.

In some embodiments, by dividing each neural network instance into neural network unit sets which can all potentially communicate in parallel, the largest amount of roundtrip data which could cause a bottleneck or otherwise become a critical path is

Max{2*k*W}.

In other words, the set of neural network units having the largest parameter update data set 920 can become the critical path for the communication portion of a neural network training time.

In some embodiments, to try to minimize Max {Wᵢ}, the neural network is designed so the size of the update parameter set Wᵢ for each neural network unit set is as similar as possible.

In some embodiments, the central nodes 930 for the different sets of neural networks are different. In some embodiments, one or more of the central nodes 930 can be located at different network locations, at different parts of a circuit/device/system, or otherwise have different communication connections to reduce or eliminate any potential communication congestion caused by potentially concurrent communications for different sets of neural network units.

In some embodiments, the same central node 930 can be used to combine update parameters for multiple or all sets of neural network units.

In some embodiments, due to the sequential nature of a neural network, update communications for one set of neural network units begin before update communications for another set of subsequent neural network units. For example, with reference to FIG. 4, in the sequential training process, the parameter update data ∇p₂ for the second layer 450B will generally be available before the parameter update data ∇p₁ for the first layer 450A because the computation in the first layer relies on output data from the second layer in the back propagation phase. Therefore, in an embodiment where the second layer 450B is in a different neural network unit than the first layer 450A, communication of the parameter update data ∇p₂ for the second layer 450B can start before communication of the parameter update data ∇p₁ for the first layer 450A. In some instances, this staggering can potentially reduce communication congestion, for example, if there is a shared network resource between different sets of neural network units.

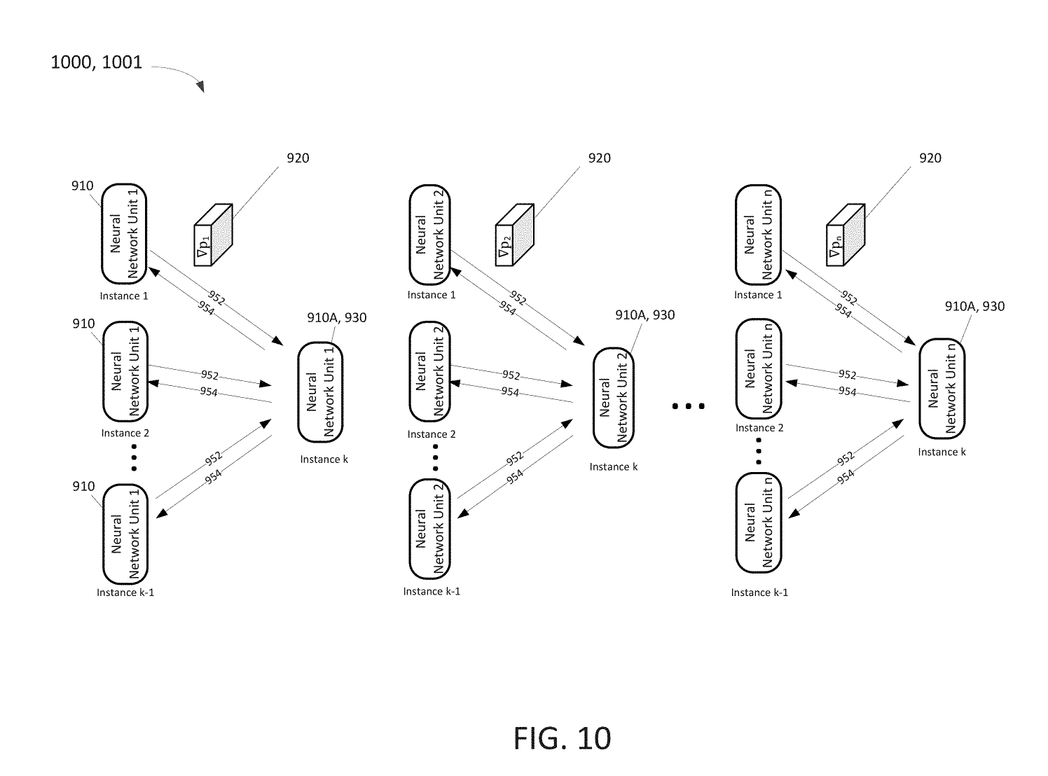

FIG. 10 shows an example data flow diagram illustrating an example parameter update process 1000 for a neural network architecture 1001. Similar to FIG. 9, the neural network architecture 1001 includes k parallel neural network instances, and each neural network instance includes an instance of each neural network unit 1 through n.

In this embodiment, the functions of the central node 930 are performed by instance k (910A) of each set of neural network units. For example, in some embodiments, neural network unit 910A is included in or is otherwise provided by the components of the central node 930.

In some embodiments, neural network unit 910A is configured to additionally perform the functions of the central node 930. For example, in some embodiments, neural network unit 910A is configured to receive and combine parameter update data from other neural network units, and to communicate the combined parameter update data to the other neural network units.

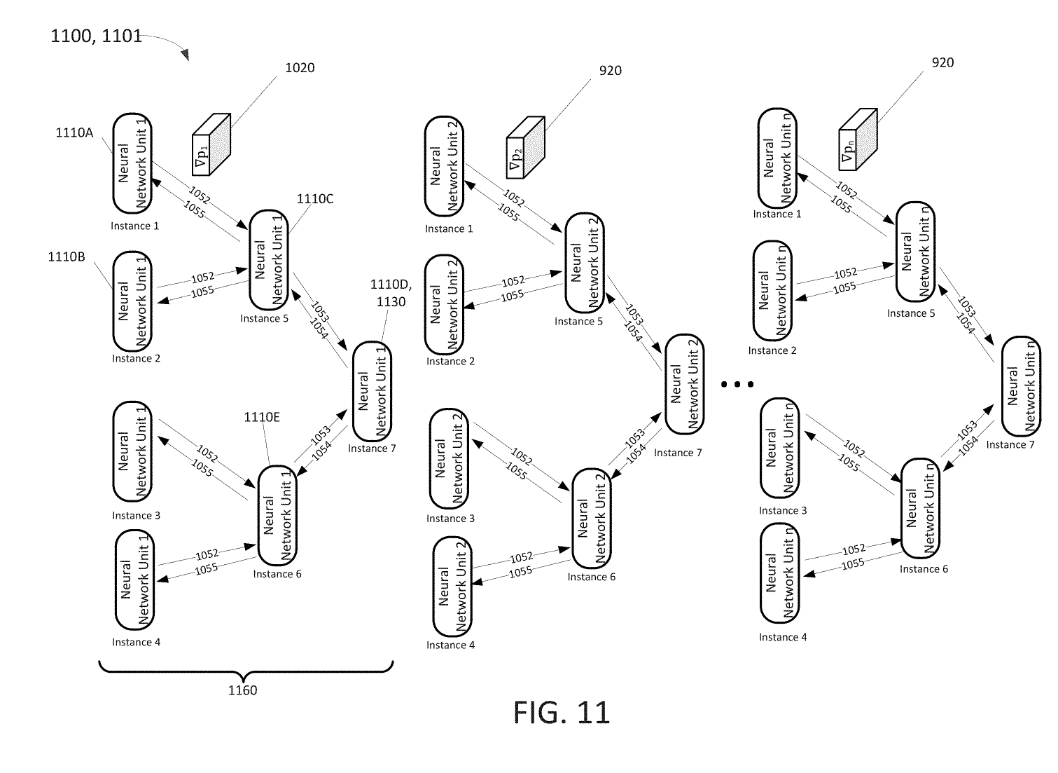

FIG. 11 shows an example data flow diagram illustrating an example parameter update process 1100 for a neural network architecture 1101. The neural network architecture 1101 includes 7 parallel neural network instances, and each neural network instance includes an instance of each neural network unit 1 through n.

The neural network units of a set 1160 are arranged in a reduction tree arrangement to communicate parameter update data to a central node 1130. For example, neural network units 1110A and 1110B communicate 1052 their parameter update data sets 1020 to neural network unit 1110C. Neural network unit 1110C combines its parameter update data set with the parameter update data sets received from neural network units 1110A and 1110B, and communicates 1053 this intermediate combined parameter update data set to the neural network unit/central node 1110D, 1130. Neural network unit 1110D combines its parameter update data set with the intermediate combined parameter update data sets received from neural network units 1110C and 1110E.

The total combined parameter update data set is then communicated 1054, 1055 in a reverse tree arrangement to each neural network unit in the set.

While the tree arrangement in FIG. 11 has k=7 instances in each neural network unit set, k in this architecture 1100 and any other architecture can be any number depending on the desired degree of parallelism.

In comparison to the example architecture of FIG. 9 in which Max {2*k*Wᵢ} bytes of data are transferred in the critical path, in the example architecture of FIG. 11, the number of bytes transferred in the critical path is on the magnitude of Max {2*log₂(k)*Wᵢ}. In some instances, this can significantly decrease the amount of bandwidth required to communicate the parameter updates, and/or may decrease the chances of a bottleneck. In some situations, this may decrease the transmission time and thereby decrease the training time for the neural network. In some situations, this may decrease the bandwidth requirements for the communication interface(s).

While the example architecture 1100 in FIG. 11 has a balanced tree arrangement, in other embodiments any other tree reduction arrangement can be used. For example, in some embodiments, the tree arrangement may have a single linear branch (e.g. a branch with neural network unit 1110A, 1110C and 1110D but not 1110B).

In some embodiments, the tree reduction arrangement may be unbalanced or otherwise non-symmetrical.

In some embodiments, rather than two neural network units communicating their parameter update data sets to the same single neural network unit, three or more neural network units can communicate their parameter update data sets. In some embodiments, this may reduce total data transmissions, but in some instances may increase the potential for communication time delays.

In an illustrative example, an embodiment of an AlexNet neural network may generate 237 MB of parameter update data across all its layers with the most data intensive layer generating 144 MB of parameter data. Using the architecture in FIG. 5, and assuming a communication bandwidth of 10 Gbps and k=32, the communication time to communicate all the parameter update data was observed to be approximately 5.925 seconds (or theoretically 237 MB*32/10 Gbps).

In comparison, using the architecture in FIG. 11 where the sets of neural network units each represent single layers of the neural network, the communication time required to communicate all the parameter update data was observed to be approximately 1.125 seconds (or theoretically 144 MB*2*log₂(32)/10 Gbps).

In some instances, this savings in communication time can be significant especially as the communication of parameter updates can be performed for thousands to millions of mini-batches.

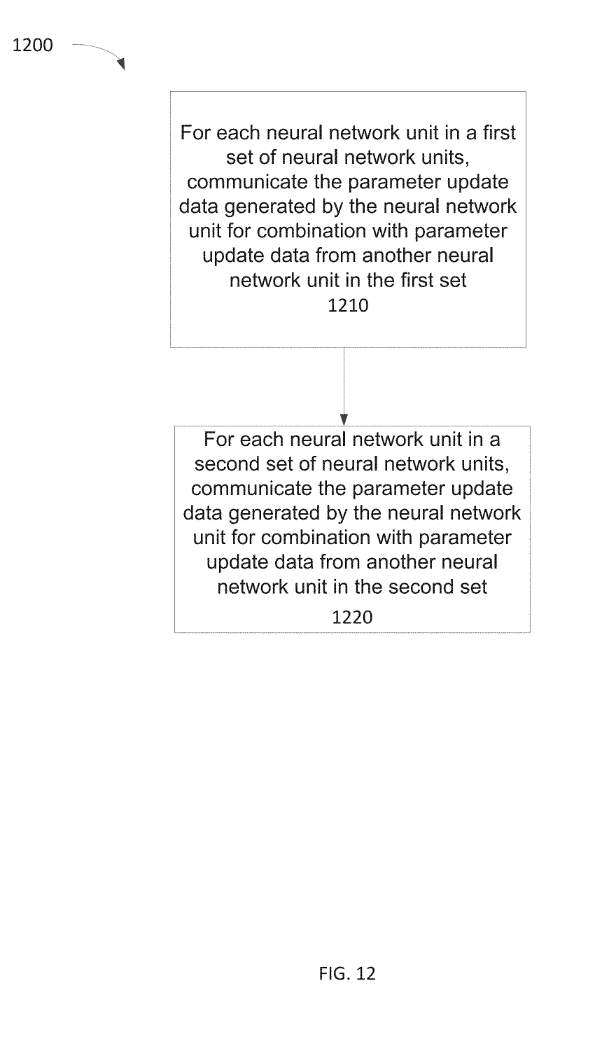

FIG. 12 illustrates a flowchart showing aspects of an example method 1200 for training a neural network.

At 1210, each neural network in a first set of neural network units communicates the parameter update data that it generated for combination with parameter update data from another neural network unit in the first set. In some embodiments, communicating the parameter update data generated by the first set of neural network units can be to a central node via its neural network units' respective communication interface.

In some embodiments, communicating the parameter update data generated by the first set of neural network units can be to another neural network unit via its neural network units' respective communication interface.

At 1220, each neural network in a second set of neural network units communicates the parameter update data that it generated for combination with parameter update data from another neural network unit in the second set.

In some embodiments, communicating the parameter update data to a central node can be via another neural network unit in the first set. In some embodiments, the method includes receiving, from a first neural network unit in the first set, parameter update data at a second neural network unit in the first set, and combining the received parameter update data of the second neural network unit with the parameter update data received from the first neural network unit.

In some embodiments, as described herein or otherwise, communicating the parameter update data generated by the neural network units in the first set is done in a reduction tree arrangement to communicate the parameter update data to a central node.

As described herein or otherwise, in some embodiments, the method includes computing or otherwise performing data processing for each stage/layer to generate intermediate data sets which may be used in the next stage and/or provided for storage in a memory device for later processing.

Aspects of some embodiments may provide a technical solution embodied in the form of a software product. Systems and methods of the described embodiments may be capable of being distributed in a computer program product including a physical, non-transitory computer readable medium that bears computer usable instructions for one or more processors. The medium may be provided in various forms, including one or more diskettes, compact disks, tapes, chips, magnetic and electronic storage media, volatile memory, non-volatile memory and the like. Non-transitory computer-readable media may include all computer-readable media, with the exception being a transitory, propagating signal. The term non-transitory is not intended to exclude computer readable media such as primary memory, volatile memory, RAM and so on, where the data stored thereon may only be temporarily stored. The computer useable instructions may also be in various forms, including compiled and non-compiled code.

Various example embodiments are described herein. Although each embodiment represents a single combination of inventive elements, all possible combinations of the disclosed elements are considered to the inventive subject matter. Thus if one embodiment comprises elements A, B, and C, and a second embodiment comprises elements B and D, then the inventive subject matter is also considered to include other remaining combinations of A, B, C, or D, even if not explicitly disclosed.

Although the present invention and its advantages have been described in detail, it should be understood that various changes, substitutions and alterations can be made herein without departing from the invention as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A system for training a neural network having a plurality of interconnected layers, the system comprising:
a first set of neural network units, each neural network unit in the first set configured to compute parameter update data for one of a plurality of instances of a first portion of the neural network, each neural network unit in the first set comprising a communication interface for communicating its parameter update data for combination with parameter update data from another neural network unit in the first set; and
a second set of neural network units, each neural network unit in the second set configured to compute parameter update data for one of a plurality of instances of a second portion of the neural network, each neural network unit in the second set comprising a communication interface for communicating its parameter update data for combination with parameter update data from another neural network unit in the second set.

2. The system of claim 1, wherein each neural network unit in the first set is configured to communicate its respective parameter update data to a central node via its respective communication interface.

3. The system of claim 1, wherein at least one of the neural network units in the first set is configured to communicate its parameter update data to another neural network unit in the first set via its communication interface.

4. The system of claim 2, wherein the central node comprises or is part of one of the neural network units in the first set.

5. The system of claim 2, where each neural network unit in the second set is configured to communicate its respective parameter update data to a second central node via its respective communication interface.

6. The system of claim 1, wherein the neural network units in the first set are arranged in a reduction tree arrangement to communicate parameter update data to a central node.

7. The system of claim 1, where each neural network unit in the first set is configured to compute input data for a respective neural network unit in the second set; the respective neural network unit in the second set configured to compute the parameter update data for the corresponding instance of the second portion of the neural network based on the input data.

8. The system of claim 7, wherein at least one neural network unit in the first set initiates communication of its respective parameter update data before the neural network units in the second set initiate communication of their parameter update data.

9. The system of claim 1, wherein the first portion of the neural network is a single layer of the neural network.

10. The system of claim 1, wherein the first portion of the neural network is at least a portion of two or more layers of the neural network.

11. A method for training a neural network with an architecture having a plurality of instances of the neural network, the method comprising:
for each neural network unit in a first set of neural network units configured to compute parameter update data for one of a plurality of instances of a first portion of the neural network, communicating the parameter update data generated by the neural network unit for combination with parameter update data from another neural network unit in the first set; and
for each neural network unit in a second set of neural network units configured to compute parameter update data for one of a plurality of instances of a second portion of the neural network, communicating the parameter update data generated by the neural network unit for combination with parameter update data from another neural network unit in the second set.

12. The method of claim 11, wherein the parameter update data computed by each of the neural network units in the first set is communicated to a central node via each neural network units' respective communication interface.

13. The method of claim 11, wherein the parameter update data computed by at least one of the neural network units in the first set is communicated to a another neural network unit in the first set via its communication interface.

14. The method of claim 12, wherein the central node comprises or is part of one of the neural network units in the first set.

15. The method of claim 12, wherein the parameter update data computed by each of the neural network units in the second set is communicated to a second central node via each neural network units' respective communication interface.

16. The method of claim 11, comprising: communicating the parameter update data generated by the neural network units in the first set in a reduction tree arrangement to communicate the parameter update data to a central node.

17. The method of claim 11, where each neural network unit in the first set is configured to compute input data for a respective neural network unit in the second set; the respective neural network unit in the second set configured to compute the parameter update data for the corresponding instance of the second portion of the neural network based on the input data.

18. The method of claim 17, comprising: initiating communication of parameter update data for at least one neural network unit in the first set before communicating the parameter update data generated by the neural network units in the second set.

19. The method of claim 11, wherein the first portion of the neural network is a single layer of the neural network.

20. A non-transitory, computer-readable medium or media having stored thereon computer-readable instructions which when executed by at least one processor configure the at least one processor to:
for each neural network unit in a first set of neural network units configured to compute parameter update data for one of a plurality of instances of a first portion of a neural network, communicate the parameter update data generated by the neural network unit for combination with parameter update data from another neural network unit in the first set; and
for each neural network unit in a second set of neural network units configured to compute parameter update data for one of a plurality of instances of a second portion of the neural network, communicate the parameter update data generated by the neural network unit for combination with parameter update data from another neural network unit in the second set.
